(19) United States
(12) Patent Application Publication
(10) Pub. No.: US 2011/0030304 A1
(43) Pub. Date: Feb. 10, 2011

(54) Stackable Platform Assembly with Improved Coupler

(75) Inventors: Matt Janowak, Fenton, MI (US); Jeremy Masser, Fenton, MI (US)

Correspondence Address: YOUNG BASILE, 3001 WEST BIG BEAVER ROAD, SUITE 624, TROY, MI, 48084, US

(73) Assignee: STRUCTURAL PLASTICS, INC., Holly, MI (US)

(21) Appl. No.: 12/909,019

(22) Filed: Oct. 21, 2010

Related U.S. Application Data
(63) Continuation of application No. 11/901,624, filed on Sep. 18, 2007.

(51) Int. Cl. E04B 5/08; F16B 17/00

(52) U.S. Cl. 52/589.1; 403/361

(57) ABSTRACT

A stackable platform assembly has an improved coupler for interconnecting a plurality of stackable platforms. The coupler has projections that are appropriately sized and spaced to facilitate frictional engagement of the coupler with platforms having different dimensions.

### CROSS-REFERENCE TO RELATED APPLICATIONS

This application is a continuation of U.S. patent application Ser. No. 11/901,624, which was filed on Sep. 18, 2007.

### FIELD OF THE INVENTION

This invention relates to coupling elements used to removably secure a plurality of platforms in stackable juxtaposition. More specifically, the invention relates to couplers capable of removably connecting platform sections having different dimensions.

### BACKGROUND OF THE INVENTION

In many industrial and commercial work environments, workers are provided with flooring surfaces which provide separation between the underlying flooring and the worker's feet. Such flooring provides thermal insulation, improves footing, and separates the worker's feet from contaminants, fluids, or moisture which may be found on the factory or workplace floor.

Often, this type of flooring is in the form of individual and repositionable panels which may be laid in the tiled fashion, if necessary interlocked. Using these techniques, selected areas in the factory or workplace floor may be covered with panels as needed.

In addition to the foregoing, it is frequently desirable to provide elevated sections of the flooring. For example, not all persons who operate machinery or other equipment from a standing position are of the same height. To ensure that operators are provided the opportunity to operate equipment at a comfortable working height, it may be desirable to raise or lower a worker's working position in relation to the machinery to minimize discomfort and fatigue. A wide variety of mats or platform-like devices have been proposed to enable persons of varying heights to be positioned at appropriate elevations during the performance of operations on a machine.

As taught in U.S. Pat. No. 5,683,004, variable heights of support structures may be constructed from a plurality of platform members which may be removably stacked through the use of coupling members. Preferably, the coupling members are uniform so that any one of them may be accommodated in sockets formed in platform members.

As known in the prior art, each coupling member comprises a cylindrical body open at one end and closed at the other end by a transverse wall. Fixed to and extending from the wall are extensions of the body section in the form of a pair of projections which are spaced apart from one another. The overall length of each coupling member is such that when the body section is accommodated in a socket, the projections extend beyond the upper surface of the associated platform a distance sufficient to engage the next adjacent platform.

Each platform has a plurality of spaced apart ribs or partitions which define an open grid construction for each platform. A part of each socket adjacent to the upper surface of each platform is spanned by at least one crossbar, thereby providing a grid configuration across the upper end of each socket.

In the prior art, the space between the two projections in each coupling member corresponds substantially to the thickness of one of the crossbars which spans the socket, thereby enabling the projections of a coupling to extend beyond the lower surface of an upper platform member and straddle the crossbar which spans the socket of the next adjacent lower platform. Preferably, space between the two projections in each coupling tapers or narrows toward the free ends of the projections, thereby enabling the projections frictionally to grip the crossbar and minimize inadvertent separation of one platform from another.

The grid configurations in each platform enable any spilled liquids or small or other parts to fall through the platform, thereby avoiding the buildup of liquids and/or contaminants on the upper surface of the platform. Preferably, the transverse wall at the closed end of each of the body sections of the couplings also has openings therein through which liquids may drain. The grid configurations of the platforms in earlier implementations of the invention were uniform, in that the thickness of the crossbars was constant, regardless of the size and shape of the platform sections. However, more recently, platform sections have been developed with higher load capabilities, necessitating thicker grid crossbars on coupling members designed for older designs of platforms that are accordingly improperly sized to engage the grid crossbar of the newer platform sections. While it is possible to solve this problem by substituting coupling members having a larger space between the projections, such coupling members will not provide a suitable friction set when used with older styled platform sections having thinner grid crossbars.

Additionally, it has been learned that suitable drainage cannot be obtained using prior art devices and that a substantially larger number of drain passageways must be incorporated.

Prior art devices are also limited in that the structural strength of the cylindrical wall of the coupling member has been shown to be insufficient, and structural changes to the coupling body to improve its strength are required. Moreover, in order to ensure interconnection of adjacent coupling members, it is necessary that the dimensions for strengthening be designed in such a fashion so as to prevent interference between the projections of the coupling and the interior of the cylindrical portion of the adjacent coupling.

An object of the present invention is, therefore, to provide a coupling member which will effectively interface with platforms having varying grid dimensions. A further object of the invention is to provide a coupling member for platform sections with the improved strength and drainage characteristics.

These, and other objects of the invention, will be apparent from the detailed description which herein follows.

### DESCRIPTION OF THE DRAWINGS

The description herein makes reference to the accompanying drawings wherein like referenced numerals refer to like parts throughout several views and wherein:

FIG. 1 is a perspective view of the critical elements of the prior art shown in exploded relationship;

FIG. 2 is a perspective view of a coupling found in the prior art;

FIG. 3 is a side view of the coupling found in the prior art;

FIG. 3A is an elevational view of a coupling found in the prior art;

FIG. 4 is a plan view of a coupling found in the prior art;

FIG. 5 is a perspective view of the important components of the invention as shown in exploded configuration;

FIG. 6 is a perspective view of the coupling of the present invention;

FIG. 7 is a side view of the coupling of the present invention;

FIG. 8 is an elevational view of a coupling as described in the present invention; and

FIG. 9 is a plan view of the coupling of the present invention.

### DESCRIPTION OF THE PRIOR ART

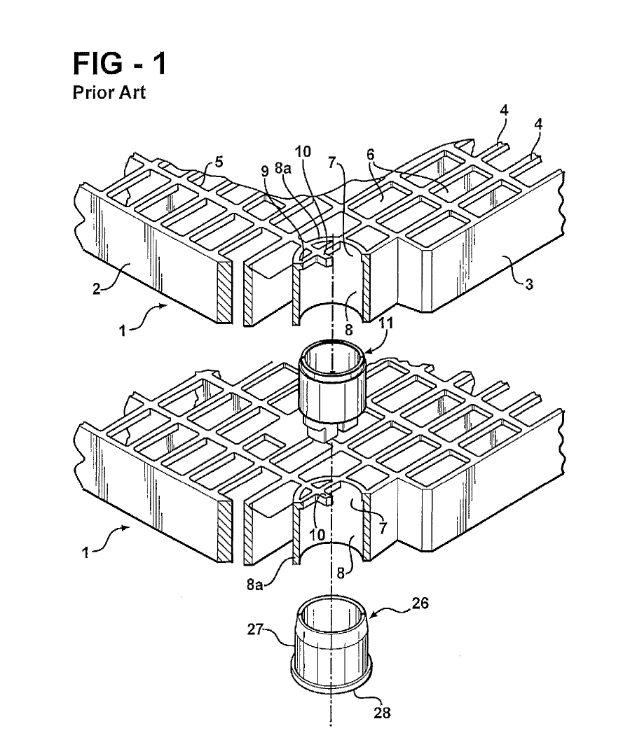

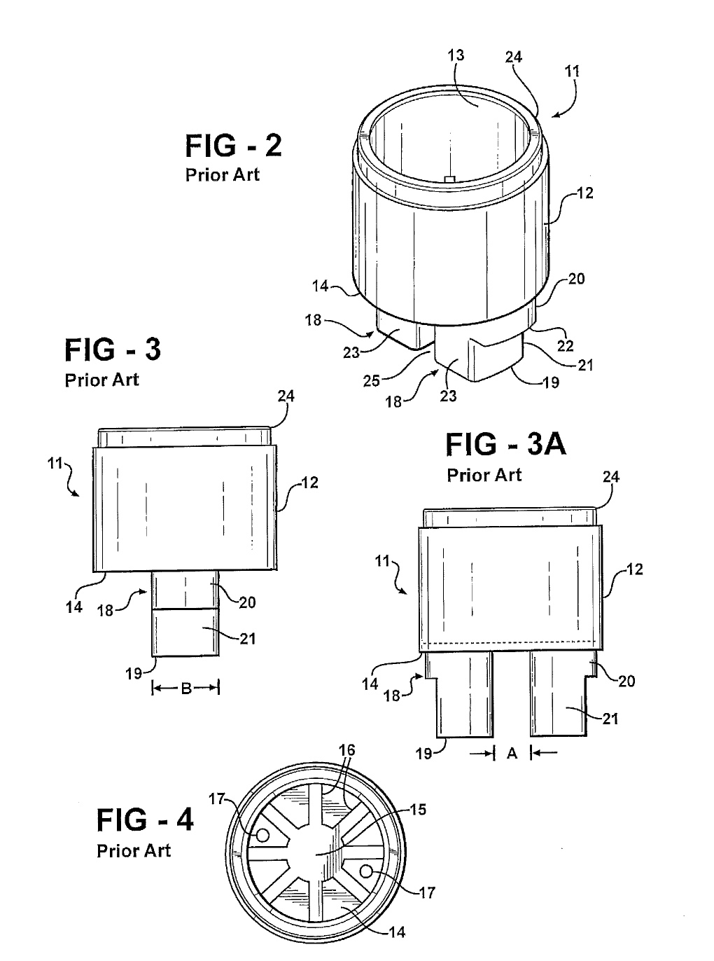

With reference now to FIGS. 1, 2, 3, 3A, and 4, the prior art over which the present invention improves will be understood.

In the prior art, a plurality of square, rectangular, or other suitably-shaped platforms 1, each of which has opposite end walls 2 joined by opposite side walls 3 and a plurality of longitudinal and transversely-extending ribs 4 and 5, respectively, form a grid having a plurality of spaces 6 therein. Each platform 1 preferably is molded of a suitable plastic having sufficient strength to support a person and which is substantially inert to oils and other liquids to which it may be subjected in the environment of its use.

At suitably spaced intervals each platform has at its lower side a cylindrical socket 7 having a smooth bore 8 and an annular wall 8a. The number and spacing of such sockets should be sufficient to enable each platform to be supported in a stable, horizontal position by a support member yet to be described. At its upper end the socket 7 is spanned by continuations of the ribs 4 and 5 to form a grid of crossbars 9 and 10 integrally formed with the remainder of the platform. The crossbars 9 and 10 span the upper end of the socket, but the opposite or lower end of the socket 7 is open. One of the crossbars, 10, extends diametrically of the socket.

A single platform 1 may be placed in such position as to support a worker at a machine operated or attended by such worker. Such platform provides adequate support for the worker and the open grid construction of the platform enables any small objects or spilled liquids to pass through the platform, rather than collect on the upper surface thereof.

Not all workers are of such height as to be able to assume a comfortable, non-tiring position alongside the machine that such worker is operating or attending. Accordingly, provision is made to enable at least one, and preferably more, like platforms to be stacked and retained in overlying relation with one another. It is important that the stacked platforms be immovable relative to one another so as to avoid the possibility that a person stepping onto or leaving the stacked platforms causes the stacked platforms to shift relative to one another.

The apparatus includes coupling means 11 for connecting adjacent, vertically stacked platforms 1 to one another. Each coupling is identical and comprises a cylindrical body section 12 having a smooth inner bore 13, the body section 12 being open at its upper end and closed at its lower end by a transverse wall 14. The inner surface of the wall has integrally formed therewith an upstanding hub 15 from which ribs 16 radiate. The hub and ribs strengthen the wall 14. To provide drainage through the coupling 11 the wall 14 has one or more drain openings 17 formed therein.

Secured to and extending from the outer surface of the wall 14 in prolongation of the body section 12 is a pair of projections 18, each of which terminates in a free end 19. Each projection 18 preferably is hollow to provide some flexibility of the projections for a purpose presently to be explained.

Each projection has adjacent its wall 14 an enlarged, outwardly arcuate portion 20 that is joined to a reduced end portion 21, the portions 20 and 21 being separated by a shoulder 22. Each side of each projection 18 has a flat surface 23.

Preferably, the outer surface of the body section 12 adjacent the free end is reduced in size, as shown at 24, which facilitates insertion of the body section into a socket 7.

To assemble a pair of platforms 1 in overlying relation, the upper platform is raised to enable a coupling 11 to be accommodated in selected sockets 7 of the upper platform. The overall height of the body section 12 preferably corresponds substantially to the height of the socket 7 so that, when the open end of the body section 12 abuts the crossbars 9 and 10, the projections 18 extend below the lower surface of the platform in which the coupling is mounted. The extent to which the projections 18 extend beyond the lower surface of the upper platform 1 is sufficient to enable the two projections to pass and straddle the diametrical crossbar 10 of the adjacent lower platform 1, the crossbar 10 being accommodated in a space 25 provided between the two extensions 18.

The radius on which the arcuate surface 21 of each projection is formed preferably is less than the radius on which the socket bore 8 is formed, but the radius on which the enlarged portion 20 of each projection is formed corresponds substantially to the radius of the bore 8 of the socket thereby enabling the enlarged portions 20 of the projections to provide lateral stability for the associated coupling when the coupling is assembled with the platform. The flat surfaces of the projections 18 enable the reduced portion of each projection to pass between parallel crossbars 9 at the upper end of the socket 7 of the lower platform.

The height of the space 25 corresponds to the full length of each projection 18, thereby enabling the outer surface of the transverse wall 14 at the closed end of the body section 12 to seat on the upper surface of the crossbar 9 and 10 which span each socket 7.

Opposite the space 125, an open-ended recess 130 is formed on the end portion 121 of each projection 118. The flat surfaces 123 of each projection 118 are spaced by the recess 130.

Preferably, the space 25 between the adjacent projections 18 has a width corresponding substantially to the thickness of the crossbar 10, but tapers toward the free ends 19 of the projections by one or two degrees. The material from which the projections is formed has sufficient resilience to enable the projections to flex, and the flexibility of the projections is enhanced by the hollow construction thereof. The taper enables the diametrical crossbar 10 to deflect the projections away from one another as the crossbar 10 moves into the space 25, and the resilience of the projections enables the crossbar to be gripped by the projections when the crossbar 10 is accommodated between the projections, thereby minimizing the likelihood of inadvertent separation of the coupling from the lower platform 1.

A ground engagable support is provided for each socket 7 of the lower platform 1. Such support as indicated at 26 and comprises a hollow cylinder 27 open at its upper end and provided at its lower end with a rubbery or other suitable cap 28 which provides an anti-skid surface for the lower end of the cylinder 27. The overall height of the cylinder 27 is such that the latter may be accommodated in any one of the sockets 7 with its upper end abutting the crossbars 9 and 10 and with its non-skid cap 28 projecting slightly beyond the lower surface of the lower platform 1. The supports 26 enable the lowermost platform to occupy a horizontal position.

The length and width of each platform should be sufficient to enable it to provide adequate space in which a person may stand and move to the extent necessary to operate or attend a particular machine.

### DESCRIPTION OF THE PREFERRED EMBODIMENT

The disclosed prior art performs well; however, it has been learned that improved performance of the platform elements can be achieved by making certain dimensional changes to the platform ribs and that the system, as a whole, will benefit from increasing drainage performance in certain industrial environments.

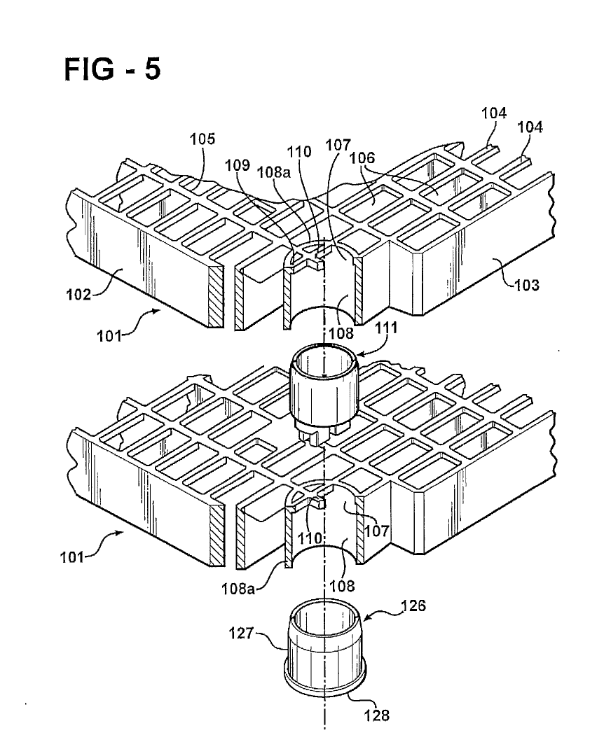

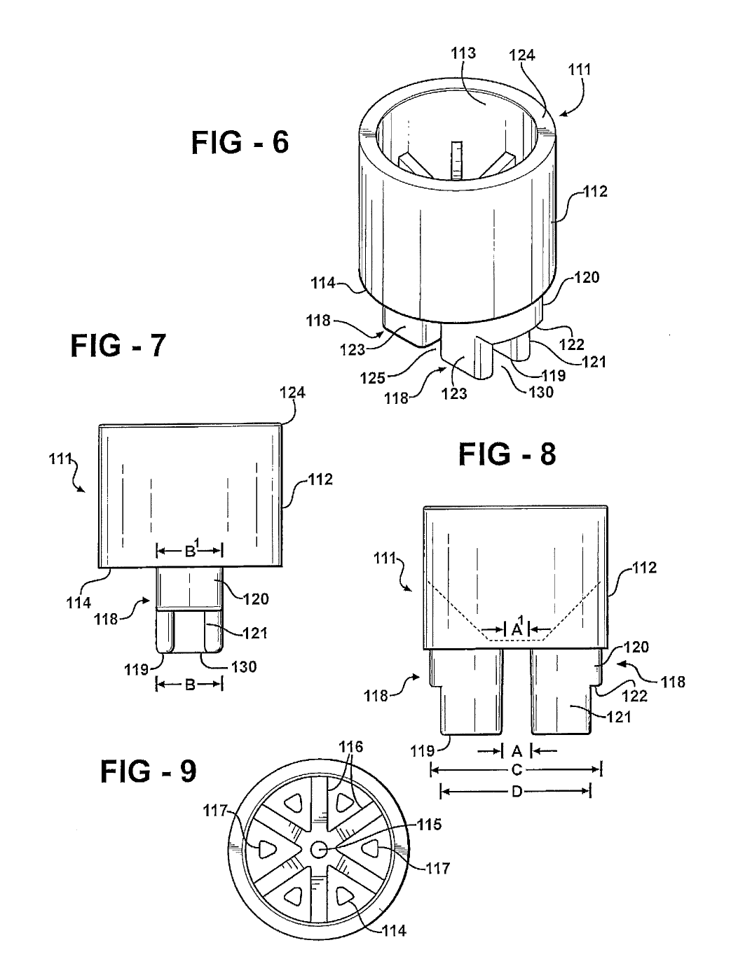

The improvement of the present invention; therefore, is described in detail below and depicted in FIGS. 5-9.

The presently preferred embodiment of the invention is illustrated in the drawings and comprises a plurality of square, rectangular, or other suitably shaped platforms 101 each of which has opposite end walls 102 joined by opposite side walls 103 and a plurality of longitudinally and transversely extending ribs 104 and 105, respectively, which form a grid having a plurality of spaces 106 therein. Each platform 101 preferably is molded of a suitable plastic having sufficient strength to support a person and which is substantially inert to oils and other liquids to which it may be subjected in the environment of its use.

At suitably spaced intervals each platform has at its lower side a cylindrical socket 107 having a bore 108 and an annular wall 108a. The number and spacing of such sockets should be sufficient to enable each platform to be supported in a stable, horizontal position by a support member yet to be described. At its upper end the socket 107 is spanned by continuations of the ribs 104 and 105 to form a grid of crossbars 109 and 110 integrally formed with the remainder of the platform. The crossbars 109 and 110 span the upper end of the socket, but the opposite or lower end of the socket 107 is open. One of the crossbars, 110, extends diametrically of the socket.

A single platform 101 may be placed in such position as to support a worker at a machine operated or attended by such worker. Such platform provides adequate support for the worker and the open grid construction of the platform enables any small objects or spilled liquids to pass through the platform, rather than collect on the upper surface thereof.

Not all workers are of such height as to be able to assume a comfortable, non-tiring position alongside the machine that such worker is operating or attending. Accordingly, provision is made to enable at least one, and preferably more, like platforms to be stacked and retained in overlying relation with one another. It is important that the stacked platforms be immovable relative to one another so as to avoid the possibility that a person stepping onto or leaving the stacked platforms causes the stacked platforms to shift relative to one another.

The apparatus includes coupling means 111 for connecting adjacent, vertically stacked platforms 101 to one another. Each coupling is identical and comprises a cylindrical body section 112 having a smooth inner bore 113, the body section 112 being open at its upper end and closed at its lower end by a transverse wall 114. The inner surface of the wall has integrally formed therewith an upstanding hub 115 from which ribs 116 radiate. The hub and ribs strengthen the wall 114. To provide drainage through the coupling 111 the wall 114 has one or more drain openings 117 formed therein.

Secured to and extending from the outer surface of the wall 114 in prolongation of the body section 112 is a pair of projections 118, each of which terminates in a free end 119. Each projection 118 preferably is hollow to provide some flexibility of the projections for a purpose presently to be explained.

Each projection has adjacent its wall 114 an enlarged, outwardly arcuate portion 120 that is joined to a reduced end portion 121, the portions 120 and 121 being separated by a shoulder 122. Each side of each projection 118 has a flat surface 123.

Preferably, the outer surface of the body section 112 is tapered, so that the diameter of the body section 112 nearest its upper end 124 is smaller than the diameter near the closed end transverse wall 114. This configuration facilitates frictional engagement between the outer cylindrical circumference of body section 112 and socket 107.

To assemble a pair of platforms 1 in overlying relation, the upper platform is raised to enable a coupling 111 to be accommodated in selected sockets 107 of the upper platform. The overall height of the body section 112 preferably corresponds substantially to the height of the socket 107 so that, when the open end of the body section 112 abuts the crossbars 109 and 110, the projections 118 extend below the lower surface of the platform in which the coupling is mounted. The extent to which the projections 118 extend beyond the lower surface of the upper platform 101 is sufficient to enable the two projections to pass and straddle the diametrical crossbar 110 of the adjacent lower platform 101, the crossbar 110 being accommodated in a space 125 provided between the two extensions 118.

The height of the space 125 corresponds to the full length of each projection 118, thereby enabling the outer surface of the transverse wall 114 at the closed end of the body section 112 to seat on the upper surface of the crossbar 109 and 110 which span each socket 107.

It will be appreciated that the distance between the projections 118 of the coupling 111 and the dimensions of crossbars 109 and 110 will enable the coupling 111 to remain immovably secured to the platform 101. Platforms 101, however, may be manufactured with varying dimensions of grid width and spacing. In some applications, diametrical crossbar 110 is characterized by a maximum width of 0.35 inches of the space 125 between adjacent projections 118 of coupler 111, accordingly, is designed to have a complimentary dimensions at free end 119, and a nominally smaller dimension closer to transverse wall 114. Accordingly, when the projections 118 of the coupling 111 are inserted to spaces 106, to straddle crossbar 110, the frictional forces exerted by projections 118 against crossbar 110 increase since dimension “A¹” as shown in FIG. 8 is nominally smaller than the dimension “A” shown in the same figure. As a result, when coupling 111 is fully inserted into platform 101 by engagement of projections 118 against rib 110, a secure frictional engagement between the coupling and the platform is achieved. In this application the invention, however, flat surfaces 123 of projections 118 are not brought into contact with crossbars 109. This is because dimension B as shown in FIG. 7 is specifically selected to ensure that the width of projections 118 between opposing flat surfaces 123 is smaller in dimension than the opening formed between two parallel crossbars 109.

Preferably, the space 125 between the adjacent projections 118 has a width corresponding substantially to the thickness of the crossbar 110, but tapers toward the free ends 119 of the projections by one or two degrees. The material from which the projections is formed has sufficient resilience to enable the projections to flex, and the flexibility of the projections is enhanced by the hollow construction thereof. The taper enables the diametrical crossbar 110 to deflect the projections away from one another as the crossbar 110 moves into the space 125, and the resilience of the projections enables the crossbar to be gripped by the projections when the crossbar 110 is accommodated between the projections, thereby minimizing the likelihood of inadvertent separation of the coupling from the lower platform 101.

A second version of platform 101 incorporates narrower crossbars 109 and 110. In this version of the platform, crossbars 109 and 110 have a width of approximately 0.325 inches. The dimension between parallel crossbars 109 is nominally 0.85 inches, which is approximately 0.05 inches less than the inter-crossbar dimension of the first type of platform 101. With reference now to FIG. 7, it will be appreciated that by making dimension B .825 inches or slightly less, and tapering the projections 118 so that dimension B¹ is 0.825 inches or slightly larger, that a frictional fit can be achieved between flat surfaces 123 and crossbars 109 when coupling 111 is used with the second style of platform 101.

In this fashion, a single coupling is disclosed which serves to couple both styles of platform 101. It is preferred that a ground engageable support be provided for each socket 107 of the lower platform 101. Such support as indicated at 126 and comprises a hollow cylinder 127 open at its upper end and provided at its lower end with a rubbery or other suitable cap 128 which provides an anti-skid surface for the lower end of the cylinder 127. The overall height of the cylinder 127 is such that the latter may be accommodated in any one of the sockets 107 with its upper end abutting the crossbars 109 and 110 and with its non-skid cap 128 projecting slightly beyond the lower surface of the lower platform 101. The supports 126 enable the lowermost platform to occupy a horizontal position.

The length and width of each platform should be sufficient to enable it to provide adequate space in which a person may stand and move to the extent necessary to operate or attend a particular machine. It is possible, of course, to have a lowermost platform of relatively great length so that upper platforms of shorter length may be supported atop the lower platform with spaces between the shorter platforms. It also is possible for the areas of upper and lower platforms to be the same.

It will be appreciated that, in the present invention, the dimension between the outer surfaces of the first stepped sections 120 of projections 118, being dimension C is selected to be substantially equal to the diameter of the inner bore 113, thereby permitting one coupling 111 to be nestable within the inner bore 113 of an adjacent coupling 111. In other words, projections 118 are fully insertable into the inner bore 113 of an identical coupling 111. Further, diametrical dimension D measured between the outermost surfaces of second step section 121 corresponds substantially to the inner diametrical bore dimension of support 126. The dimension E of first stepped section 120 is selected to be substantially equal to the thickness of crossbars 109 and 110, so that when coupling 111 is inserted into socket 107 of platform 101, only the second step section 121 of legs 118 projects into the bore 108. In this fashion, the outer circumference of support 126 frictionally engages the bore 108, while the inner bore of support 126 accommodates second stop section 121 of legs 118, thereby adding to the security and stability of the assembly. Dimension D is also smaller than the diametrical dimension of the inner bore 113, thereby permitting coupling 111 to be inserted from the underside of platform 101 into bore 107, thereby facilitating the stacking of multiple platforms 110 utilizing multiple couplings 111.

The disclosed embodiment is representative of the presently preferred form of the invention, but is intended to be illustrative rather than definitive thereof. The invention is defined in the claims.

What is claimed is:

1. A stackable platform assembly, comprising:
a plurality of platforms, each platform having a vertically extending socket, each vertically extending socket having an annular wall, at least one diametrical cross member and at least two transverse cross members perpendicular to said diametrical cross member, the vertically extending socket having either of a first configuration or a second configuration; and
a coupler including:
a body section adapted to be received within the vertically extending socket of a first platform of the plurality of platforms for engagement with the annular wall thereof, and
a pair of projections that extend downwardly from said body section, the projections separated by a space that tapers to widen in a first direction at an open end thereof opposite the body section, each projection having a pair of transverse walls that cooperate to define a tapered transverse width in a second direction for each projection that narrows at a free end, the second direction being perpendicular to the first direction,
wherein the projections are adapted to selectively define a either of a first friction fit with respect to the vertically extending socket of a second platform of the plurality of platforms, wherein the diametrical cross member of the socket is received within the space for frictional engagement with the projections and the transverse cross members are spaced from the projections, or a second friction fit with respect to the vertically extending socket of the second platform of the plurality of platforms, wherein the transverse cross members are engaged with respective ones of the transverse walls of the projections and the diametrical cross member is spaced from the projections, wherein the first friction fit is defined when the vertically extending socket has the first configuration and the second friction fit is defined when the vertically extending socket has the second configuration.

2. The stackable platform assembly of claim 1, further comprising:
the diametrical cross member of the vertically extending socket having a first diametrical cross member width in the first configuration and the diametrical cross member of the socket having a second diametrical cross member width in the second configuration, the second diametrical cross member width being smaller than the first width.

3. The stackable platform assembly of claim 2, further comprising:
the space between the projections being substantially equal to the first diametrical cross member width.

4. The stackable platform assembly of claim 1, further comprising:
the transverse cross members of the vertically extending socket separated by a first transverse spacing in the first configuration and the transverse cross members of the vertically extending socket separated by a second transverse spacing in the second configuration the second transverse spacing being smaller than the first transverse spacing.

5. The stackable platform assembly of claim 4, further comprising:
the transverse walls of each projection being spaced such that a projection width for each projection is substantially equal to said second transverse spacing.

6. The coupler of claim 1, further comprising:
an open ended recess defined by each projection between the transverse walls thereof opposite the space between the projections, wherein the transverse walls of each projection spaced from each other by the open ended recess.

7. The coupler of claim 1, further comprising:
a plurality of ribs positioned radially within an internal cavity in said coupler, the ribs tapering downward toward the center of the coupler.
